(19) United States
(12) Patent Application Publication
(10) Pub. No.: US 2024/0067516 A1
(43) Pub. Date: Feb. 29, 2024

(54) VENTED SIDE AIR CHANNEL SPOUT

(71) Applicant: Xuan Zeng, Warren, NJ (US)

(72) Inventor: Xuan Zeng, Warren, NJ (US)

(21) Appl. No.: 17/897,191

(22) Filed: Aug. 28, 2022

(51) Int. Cl. B67D 7/00

(52) U.S. Cl. CPC B67D 7/005

(57) ABSTRACT

This vented spout relates to a detachable pouring spouts that can be used to transfer liquid contents from a filling container to a receiving container. More particularly, the present invention relates to a detachable self-venting, non-spilling pouring spout. This vented spout has a side air channel or air channels including one way valves that prevent liquid back out from the air channel and also does not reduce the pouring orifice cross section which would result in accelerating the flow rate of substance. The vented spout has a thread shape portion which will create spinning flow and enhancing flow rate as well. It's also flexible so that the spout can be bend to different directions which helps reduces storage space due to the bending.

### FIELD OF INVENTION

This invention relates to hydromechanics field, more particularly, the present invention relates to a detachable self-venting, non-spilling pouring spout. In the preferred embodiment, the present invention is a self-venting spout that allows for smooth transfer of liquid materials from a non-vented holding container to a receiving container. It will allow the liquid flow out much faster than a non-vented or other existing vented spouts with consistent venting effectiveness.

### BACKGROUND OF INVENTION

Most commercial used chemicals or other liquids such as DEF or petroleum products are stored in plastic or metal containers for easy transportation and trading. A spout will be used when pouring chemical liquid from container to a receiving vessel. It's desired that the chemical transferring process is as fast as possible due to bad smell or other concerns. It's also desire to have very low cost spout due to commercial consideration. A spout has a connecting cap and a long tube. Normal non vented spouts will have very slow flow rate or sometimes no flow at all since the air pressure outside of the container will be much higher than the pressure inside container. Other vented spout in the market has small tube size or inconsistent venting effect due to its structure limitations.

### DESCRIPTION OF THE RELATED ART

My invention is a vented spout that can increase flow rate, and reduce liquid transferring time during pouring. The spout has a cap, neck portion with a side air channel or air channels, a thread shape tube and straight end portion. The side air channel has a plastic valve that prevents liquid back out from the air channel.

This present invention from the side air channel will allow spout's up air pressure higher than the end of spout when pouring liquid out from container, which will add additional force to help chemical liquid deplete quickly. During pouring chemical liquid process, the air from air channel will get into flowing liquid and, form small air bubbles. Some small air bubbles will flow back into container and create balanced air pressure inside and out of container. Some air bubbles will mix with liquid, creating irregular flow, which will change the air pressure from bottom, and allow flow quicker. The thread shape portion of spout will create a spinning liquid flow, which will accelerate flow speed as well. It is flexible and can be bended to different directions which reduce storage space due to the bending.

This design will help pouring chemical fast with a very low cost since this designed spout is one piece that can be blow molded. It's one piece design with same material which will create consistent venting effect.

Accordingly, it is an object of the present invention to provide an improved pouring spout for use with dispensing containers of the side vented spout type that will provide increased venting reliability.

### SUMMARY OF INVENTION

This invention has been developed in response to the present state of the art, and in particular, in response to the problems and needs in the art that have not yet been fully solved by currently available non-vented or vented spout. Accordingly, the present invention has been developed to provide require that the chemical liquid can be poured out quickly due to bad smell or other concerns. It also require a very low cost product. My spout will help pouring chemical liquid much fast with a very low cost since our spout is one piece that can be blow molded. It has consistent venting effect. The present invention is also directed to a vented spout with side air channel and is self-storing when not connected to the fluid container.

An advantage of the present invention is that the side air channel does not reduce the pouring orifice cross section which would result in accelerating the flow rate of substances.

Another advantage of the present invention is that the thread shape tube portion is flexible and can be bended to different directions which reduce storage space due to the bending.

Furthermore, another advantage is that the present invention is a one piece design that will keep venting effect consistent.

### BRIEF DESCRIPTION OF THE DRAWING

The invention will now be described in detail by way of example and with references to the accompanying drawings in which:

FIG. 1: Front view

FIG. 2: Left side view;

FIG. 3: 3D View;

FIG. 4: A variation design with two thread shape portions;

FIG. 5: A variation design with two side air channels.

FIG. 6: Section view of neck portion from FIG. 1, showing one way valve inside air channel.

FIG. 7: The illustration of pouring liquid from container through sprout.

### INDEX REFERENCE

1. Connection Cap
2. Neck Portion
3. Thread Shape Tube
4. End Portion
5. Side Air Channel
6. One Way Valve Body
7. One Way Valve Guard Plate

### DETAILED DESCRIPTION OF DRAWINGS

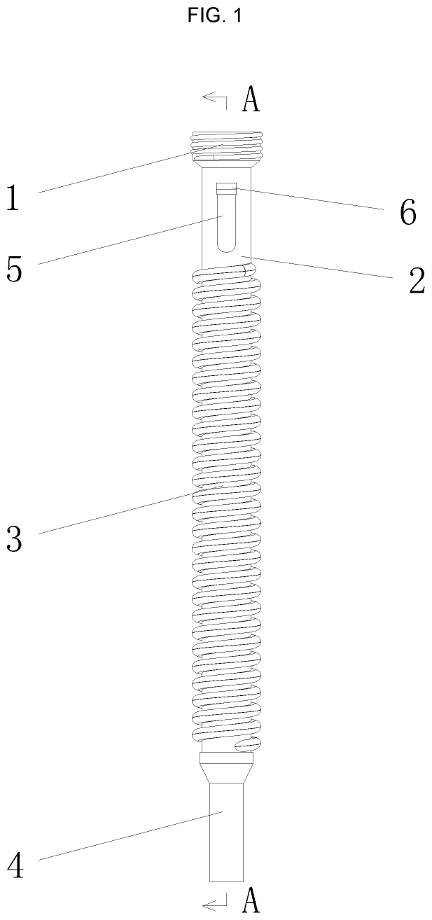

FIG. 1 shows the front view which shows the side air channel which does not reduce the pouring orifice cross section which would result in accelerating the flow rate of substances.

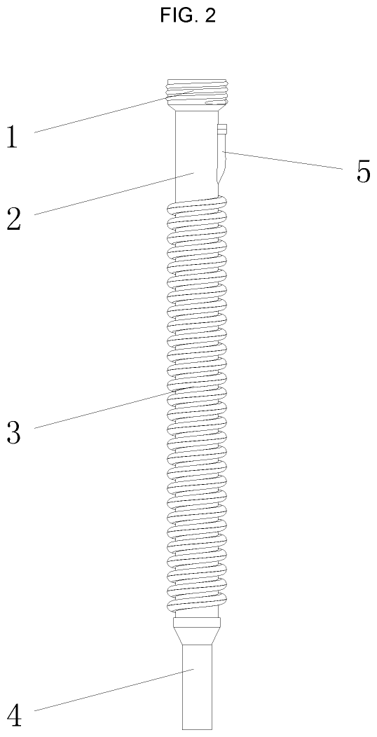

FIG. 2 shows the left side view of the spout which reveal the thread in the left side view.

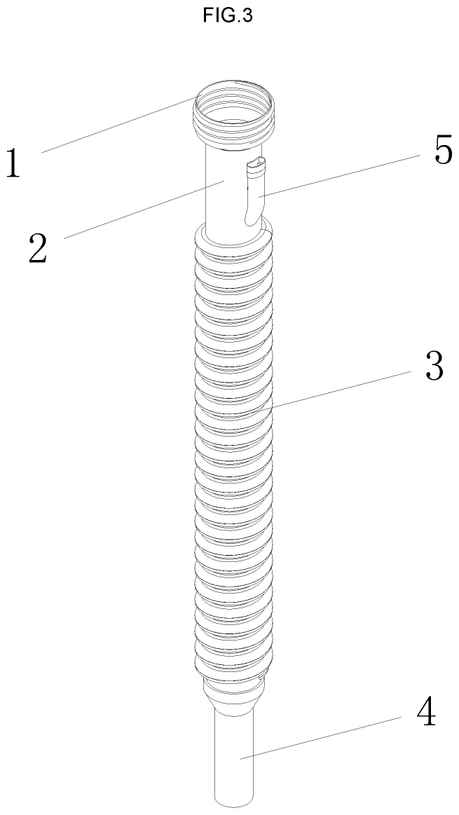

FIG. 3 shows the 3D view part of the vented spout.

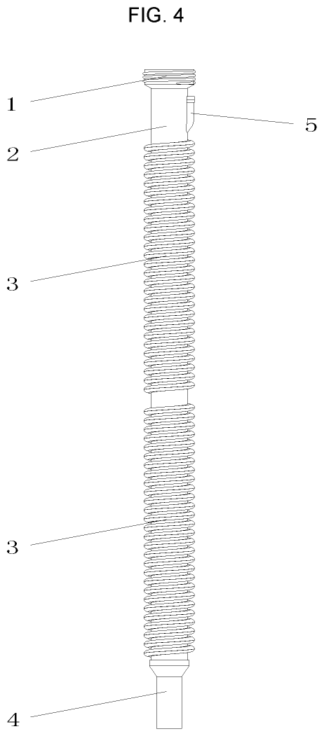

FIG. 4 shows a variation design with two thread shape portion that makes the spout bendable.

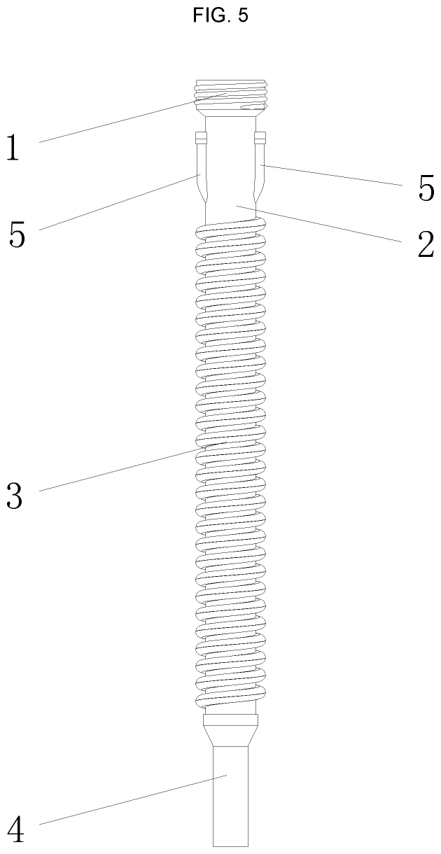

FIG. 5 shows a variation design with two side air channels view.

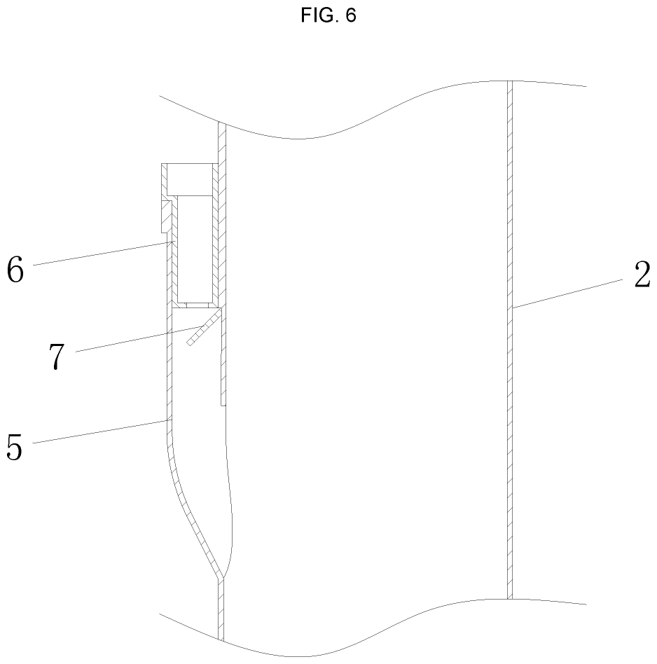

FIG. 6 shows the section view of neck tube portion from FIG. 1, showing one way valve inside air channel.

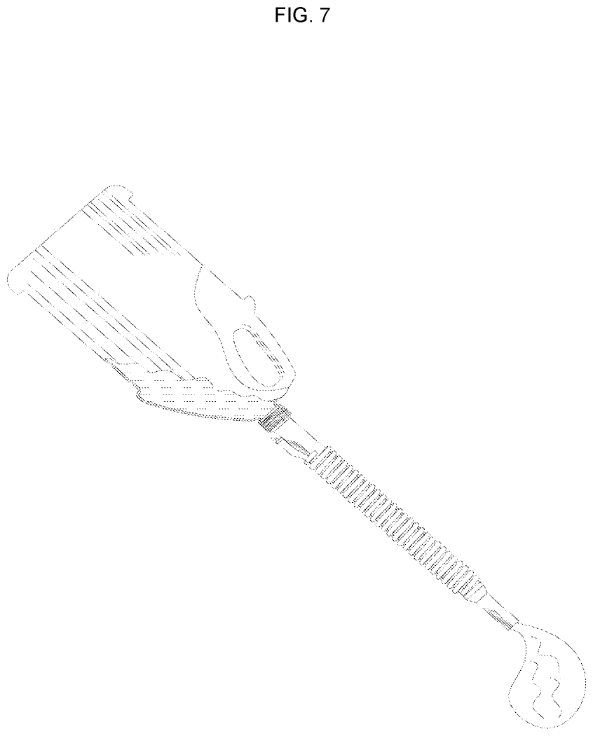

FIG. 7 shows illustration of pouring liquid from container through sprout.

1. A vented spout relates to a detachable pouring spouts that can be used to transfer liquid contents from a filling container to a receiving container. More particularly, the present invention relates to a detachable self-venting, non-spilling pouring spout.

2. A vented spout that has a cap, neck portion with a side air channel, a thread shape tube and straight end portion.

3. A vented with a side air channel that has a plastic valve design that prevent liquid back out from the air channel and also does not reduce the pouring orifice cross section which would result in accelerating the flow rate of substances.

4. A vented spout that has a thread shape middle portion, which will make liquid spinning when depleting. It will accelerate the flowing rate. It's also flexible so that the spout can be bend to different directions.

5. This vented spout will help pouring chemical as fast as it allows to with a very low cost since it is one piece that can be blow molded.

6. There is a one way valve inside side air channel, to prevent liquid back up from air channel.
